(19) United States
(12) Patent Application Publication
(10) Pub. No.: US 2025/0232509 A1
(43) Pub. Date: Jul. 17, 2025

(54) METHOD AND APPARATUS FOR DISPLAYING VIRTUAL SCENE PICTURE, DEVICE, MEDIUM, AND PROGRAM PRODUCT

(71) Applicant: Tencent Technology (Shenzhen) Company Limited, Shenzhen (CN)

(72) Inventors: Jinming Ma, Shenzhen (CN); Jian Cao, Shenzhen (CN)

(21) Appl. No.: 19/171,065

(22) Filed: Apr. 4, 2025

Related U.S. Application Data
(63) Continuation of application No. PCT/CN2024/080113, filed on Mar. 5, 2024.

(30) Foreign Application Priority Data
Apr. 27, 2023 (CN) 202310481448.9

(51) Int. Cl. G06T 13/80

(52) U.S. Cl. CPC G06T 13/80; G06T 2200/24

(57) ABSTRACT

A method for updating a virtual scene picture is performed by a computer device. The method includes: displaying a virtual scene picture of a cloud game transmitted by a cloud server by rendering first picture data; displaying an effect switching region comprising at least one candidate picture display effect; submitting, based on a user selection operation for a first picture display effect in the at least one candidate picture display effect, the first picture display effect to the cloud server, wherein the first picture display effect is different from the default display effect; receiving second picture data transmitted by the cloud server, wherein the cloud server generates the second picture data by adjusting the first picture data according to the first picture display effect; and updating the virtual scene picture to have the first picture display effect by rendering the second picture data transmitted by the cloud server.

### CROSS-REFERENCE TO RELATED APPLICATIONS

This application is a continuation application of PCT Patent Application No. PCT/CN2024/080113, entitled “METHOD AND APPARATUS FOR DISPLAYING VIRTUAL SCENE PICTURE, DEVICE, MEDIUM, AND PROGRAM PRODUCT” filed on Mar. 5, 2024, which claims priority to Chinese Patent Application No. 202310481448.9, entitled “METHOD AND APPARATUS FOR DISPLAYING VIRTUAL SCENE PICTURE, DEVICE, MEDIUM, AND PROGRAM PRODUCT” filed on Apr. 27, 2023, both of which are incorporated by reference in their entirety.

### FIELD OF THE TECHNOLOGY

Embodiments of this application relate to the field of animation generation, and in particular, to a method and an apparatus for displaying a virtual scene picture, a device, a medium, and a program product.

### BACKGROUND OF THE DISCLOSURE

With the improvement of cultural and entertainment living standards, people have increasingly higher life experience and requirements on virtual scenes. As a representation manner of the virtual scenes, games become a channel for many people to seek interestingness. In a game application, rich game scenes are beneficial to improving a display effect of a game picture and improving a sense of participation of a player in the game.

In related technologies, the player participates in a game process by downloading the game, and implements corresponding functions according to functional options provided by the game. For example, the player selects a displayed scene form based on scene selection options provided in the local game, and downloads a selected scene on a local client, to display the selected scene.

However, in the foregoing process, a limitation in which a scene switching process relies on the local game exists. If the amount of to-be-rendered data corresponding to scene switching is relatively large, it is easy that data cannot be accurately and completely rendered to a device, affecting game use experience of a user.

### SUMMARY

Embodiments of this application provide a method and an apparatus for displaying a virtual scene picture, a device, a medium, and a program product, which can avoid a limitation that a picture display effect can be changed only based on downloading. A cloud server is used to efficiently and targetedly adjust first picture data corresponding to a virtual scene picture, thereby improving flexibility of adjusting the picture display effect. Technical solutions are as follows:

According to an aspect, a method for displaying a virtual scene picture is performed by a computer device, and the method includes:
displaying a virtual scene picture of a cloud game transmitted by a cloud server, wherein the cloud server generates the virtual scene picture by rendering first picture data according to a default display effect;
displaying an effect switching region comprising at least one candidate picture display effect;
submitting, based on a user selection operation for a first picture display effect in the at least one candidate picture display effect, the first picture display effect to the cloud server, wherein the first picture display effect is different from the default display effect;
receiving second picture data transmitted by the cloud server, wherein the cloud server generates the second picture data by adjusting the first picture data according to the first picture display effect; and
updating the virtual scene picture to have the first picture display effect by rendering the second picture data transmitted by the cloud server.

According to another aspect, a computer device is provided, including a processor and a memory, the memory having at least one instruction, at least one program, a code set, or an instruction set stored therein, the at least one instruction, the at least one program, the code set, or the instruction set being loaded and executed by the processor to implement the method for updating a virtual scene picture according to any one of the foregoing embodiments of this application.

According to another aspect, a non-transitory computer-readable storage medium is provided, having at least one instruction, at least one program, a code set, or an instruction set stored therein, the at least one instruction, the at least one program, the code set, or the instruction set being loaded and executed by a processor to implement the method for updating a virtual scene picture according to any one of the foregoing embodiments of this application.

The technical solutions provided in the embodiments of this application include at least the following beneficial effects:

In a cloud game scene, a virtual scene picture of a cloud game is displayed after first picture data transmitted by a cloud server is rendered, an effect switching region is displayed after a display effect switching operation is received, and the virtual scene picture having a first picture display effect obtained by rendering second picture data transmitted by the cloud server is displayed based on a selection operation for the first picture display effect, where the second picture data is data obtained by adjusting the first picture data by using the first picture display effect by the cloud server. The cloud server is used to adjust a picture display effect of the virtual scene picture, to avoid a limitation that the picture display effect can be changed only after the picture display effect is locally downloaded. The cloud server can be used to efficiently and targetedly adjust the first picture data corresponding to the virtual scene picture, thereby improving flexibility and improving efficiency of displaying the virtual scene picture having the first picture display effect.

### BRIEF DESCRIPTION OF THE DRAWINGS

FIG. 1 is a structural block diagram of an electronic device according to an exemplary embodiment of this application.

FIG. 2 is a structural block diagram of a computer system according to an exemplary embodiment of this application.

FIG. 3 is a flowchart of a method for displaying a virtual scene picture according to an exemplary embodiment of this application.

FIG. 4 is a flowchart of a method for displaying a virtual scene picture according to another exemplary embodiment of this application.

FIG. 5 is a schematic diagram of an interface of a functional region according to an exemplary embodiment of this application.

FIG. 6 is a schematic diagram of an interface of an effect intensity adjustment region according to an exemplary embodiment of this application.

FIG. 7 is a flowchart of a method for displaying a virtual scene picture according to still another exemplary embodiment of this application.

FIG. 8 is a schematic diagram of an interface of an effect switching region according to an exemplary embodiment of this application.

FIG. 9 is a flowchart of a method for displaying a virtual scene picture according to yet another exemplary embodiment of this application.

FIG. 10 is a flowchart of an overall technology of a method for displaying a virtual scene picture according to an exemplary embodiment of this application.

FIG. 11 is a schematic diagram of an interface of performing black-and-white effect conversion on a virtual scene picture according to an exemplary embodiment of this application.

FIG. 12 is a flowchart of an algorithm of a cloud server during black-and-white effect conversion according to another exemplary embodiment of this application.

FIG. 13 is a schematic diagram of an interface of performing sharpen effect conversion on a virtual scene picture according to an exemplary embodiment of this application.

FIG. 14 is a schematic diagram of an interface of performing pencil effect conversion on a virtual scene picture according to an exemplary embodiment of this application.

FIG. 15 is a flowchart of a method for displaying a virtual scene picture performed by a cloud server according to an exemplary embodiment of this application.

FIG. 16 is a structural block diagram of an apparatus for displaying a virtual scene picture according to an exemplary embodiment of this application.

FIG. 17 is a structural block diagram of an apparatus for displaying a virtual scene picture according to another exemplary embodiment of this application.

FIG. 18 is a structural block diagram of a terminal according to an exemplary embodiment of this application.

### DESCRIPTION OF EMBODIMENTS

First, terms involved in the embodiments of this application are briefly introduced.

Virtual scene: The virtual scene is displayed (or provided) when an application program is run on a terminal. The virtual scene may be a simulated scene of a real scene or may be a semi-simulated and semi-fictional virtual scene, or may be a completely fictional virtual scene. The virtual scene may be any one of a two-dimensional virtual scene, a 2.5-dimensional virtual scene, and a three-dimensional virtual scene. This is not limited in this application. Description is made by using an example in which the virtual scene is a three-dimensional virtual scene in the following embodiments.

Virtual model: The virtual model is a model configured to imitate a real scene in a virtual scene. For example, the virtual model occupies a volume in the virtual scene. For example, the virtual model includes: a terrain model, a building model, an animal and plant model, a virtual item model, a virtual vehicle model, and a virtual object model. For example, the terrain model includes: a ground, a mountain, a water stream, a stone, a step, and the like; the building model includes: a house, a wall, a container, and fixed facilities inside a building: a desk, a chair, a case, a bed, and the like; the animal and plant model includes: a tree, a flower, a bird, and the like; the virtual item model includes: a virtual attack item, a medicine box, an air-drop, and the like; the virtual vehicle model includes: an automobile, a ship, a helicopter, and the like; and the virtual object model includes: a person, an animal, an animated person, and the like.

Virtual character/virtual object: The virtual character/virtual object is a movable object in a virtual scene. The movable object may be a virtual character, a virtual animal, a cartoon character, or the like, for example, a character, an animal, a plant, an oil drum, a wall, or a stone displayed in the three-dimensional virtual scene. In one embodiment, the virtual object is a three-dimensional model created based on a skeletal animation technology. Each virtual object has a shape and a volume in the three-dimensional virtual scene and occupies some space in the three-dimensional virtual scene.

In the embodiments of this application, a method for displaying a virtual scene picture is provided, which can avoid a limitation that a picture display effect can be changed only based on downloading. A cloud server is used to efficiently and targetedly adjust first picture data corresponding to a virtual scene picture, thereby improving flexibility of adjusting the picture display effect. The method for displaying a virtual scene picture obtained in this application is applied to at least one of a plurality of virtual scenes such as a virtual battle scene, a virtual shooting scene, and a virtual interaction scene. The foregoing application scenes are merely exemplary examples, and the method for displaying a virtual scene picture provided in this embodiment may alternatively be applied to another scene. These are not limited in the embodiments of this application.

In this application, before and during acquisition of relevant data of a user, a prompt interface or a pop-up window may be displayed, or speech prompt information may be outputted. The prompt interface, the pop-up window, or the speech prompt information is configured for prompting the user that relevant data of the user is currently being acquired. In this way, in this application, only after a confirmation operation performed by the user for the prompt interface or the pop-up window is obtained, the relevant steps of obtaining the relevant data of the user start to be performed. Otherwise (in other words, when the confirmation operation performed by the user for the prompt interface or the pop-up window is not obtained), the relevant steps of obtaining the relevant data of the user are ended, that is, the relevant data of the user is not obtained. In other words, all user data acquired in this application is acquired with user consent and authorization, and acquisition, use, and processing of relevant user data need to comply with relevant laws, regulations, and standards of relevant regions.

A terminal in this application may be a desktop computer, a laptop computer, a mobile phone, a tablet computer, an e-book reader, a moving picture experts group audio layer III (MP3) player, a moving picture experts group audio layer IV (MP4) player, or the like. An application program supporting a virtual environment, for example, an application program supporting the three-dimensional virtual environment, is installed and run on the terminal. The application program may be any one of a virtual reality (VR) application program, a three-dimensional map program, a third-person shooting (TPS) game, a first-person shooting (FPS) game, a multiplayer online battle arena (MOBA) game, and the like. In one embodiment, the application program may be a standalone application program, such as a standalone three-dimensional game program; or may be a network-connected application program.

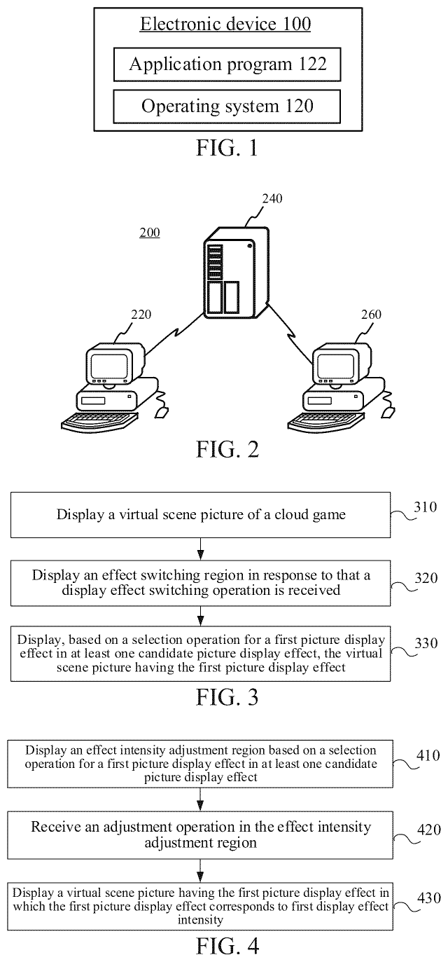

FIG. 1 is a structural block diagram of an electronic device according to an exemplary embodiment of this application. An electronic device 100 includes an operating system 120 and an application program 122.

The operating system 120 is basic software provided for the application program 122 to perform secure access to computer hardware.

The application program 122 is an application program supporting a virtual environment. In one embodiment, the application program 122 is an application program supporting a three-dimensional virtual environment. The application program 122 may be any one of a virtual reality application program, a three-dimensional map program, a TPS game, an FPS game, a MOBA game, and a multi-player shootout survival game. The application program 122 may be a standalone application program, such as a standalone three-dimensional game program; or may be a network-connected application program.

FIG. 2 is a structural block diagram of a computer system according to an exemplary embodiment of this application. A computer system 200 includes a first device 220, a server 240, and a second device 260.

An application program supporting a virtual environment is installed and run on the first device 220. The application program may be any one of a virtual reality application program, a three-dimensional map program, a TPS game, an FPS game, a MOBA game, and a multi-player shootout survival game. The first device 220 is a device used by a first user. The first user uses the first device 220 to control a first virtual object in the virtual environment to perform an action. The action includes, but is not limited to, at least one of body posture adjustment, crawling, walking, running, cycling, jumping, driving, picking, shooting, attacking, and throwing. For example, the first virtual object is a first virtual character such as a simulated character role or a cartoon character role.

The first device 220 is connected to the server 240 by using a wireless network or a wired network.

The server 240 includes at least one of one server, a plurality of servers, a cloud computing platform, and a virtualization center. The server 240 is configured to provide a backend service for an application program supporting a three-dimensional virtual environment. In one embodiment, the server 240 is responsible for primary computing work, and the first device 220 and the second device 260 are responsible for secondary computing work. Alternatively, the server 240 is responsible for secondary computing work, and the first device 220 and the second device 260 are responsible for primary computing work. Alternatively, the server 240, the first device 220, and the second device 260 perform collaborative computing by using a distributed computing architecture among each other.

An application program supporting a virtual environment is installed and run on the second device 260. The application program may be any one of a virtual reality application program, a three-dimensional map program, an FPS game, a MOBA game, and a multi-player shootout survival game. The second device 260 is a device used by a second user. The second user uses the second device 260 to control a second virtual object in the virtual environment to perform an action. The action includes, but is not limited to, at least one of body posture adjustment, crawling, walking, running, cycling, jumping, driving, picking, shooting, attacking, and throwing. For example, the second virtual second is a second virtual character, such as a simulated character role or a cartoon character role.

In one embodiment, the first virtual character and the second virtual character are located in the same virtual environment. In one embodiment, the first virtual character and the second virtual character may belong to the same team or the same organization, have a friend relationship, or have a temporary communication permission. In one embodiment, the first virtual character and the second virtual character may alternatively belong to different teams, different organizations, or two groups hostile to each other.

In one embodiment, the application programs installed on the first device 220 and the second device 260 are the same, or the application programs installed on the two devices are the same type of application programs of different control system platforms. The first device 220 may generally refer to one of a plurality of devices, and the second device 260 may generally refer to one of a plurality of devices. In this embodiment, description is made by using only the first device 220 and the second device 260 as an example. A device type of the first device 220 and a device type of the second device 260 may be the same or may be different. The device type includes at least one of a game console, a desktop computer, a smartphone, a tablet computer, an e-book reader, an MP3 player, an MP4 player, and a laptop computer. In the following embodiments, description is made by using an example in which the device is a desktop computer.

A person skilled in the art may learn that there may be more or fewer devices. For example, there may be only one device, or there may be dozens of or hundreds of or more devices. The quantity of devices and the device type of the device are not limited in the embodiments of this application.

The server 240 may be implemented as a physical server, or may be implemented as a cloud server in a cloud. A cloud technology is a hosting technology that unifies a series of resources such as hardware, software, and networks in a wide area network or a local area network to implement computing, storage, processing, and sharing of data. The cloud technology is a collective name of a network technology, an information technology, an integration technology, a management platform technology, an application technology, and the like based on an application of a cloud computing business mode, and may form a resource pool, which is used as required, and is flexible and convenient.

In some embodiments, the method provided in the embodiments of this application may be applied to a cloud game scene, so that the cloud server completes computing of data logic in a game process, and a terminal is responsible for displaying a game interface.

In some embodiments, the server 240 may alternatively be implemented as a node in a blockchain system.

The method for displaying a virtual scene picture provided in this application is described with reference to the brief introduction of terms and application scenes described above. Description is made by using an example in which the method is applied to a terminal. As shown in FIG. 3, the method includes operation 310 to operation 330 described below.

Operation 310: Display a virtual scene picture of a cloud game.

The cloud game is a game manner based on cloud computing, and is configured to represent a game in which a cloud server processes an operation process related to the game. In a running mode of the cloud game, the game does not need to be downloaded on the terminal, and computing related to the game is run on the cloud server. The cloud server compresses a game picture obtained through rendering and transmits the game picture to the terminal, so that the terminal displays the virtual scene picture corresponding to the cloud game.

The virtual scene picture is a picture obtained by rendering first picture data transmitted by the cloud server.

In one embodiment, a player selects a cloud game A through a web page on the terminal. The terminal generates game operation data based on an operation performed by the player for the game on the web page, and transmits the game operation data to the cloud server. The cloud server determines first picture data corresponding to the cloud game A based on the game operation data, and transmits the first picture data to the terminal, so that the terminal renders the first picture data to obtain a virtual scene picture.

In one embodiment, a cloud game application program is installed on the terminal. The cloud game application program is a cross-terminal game platform, and is configured to provide a plurality of cloud game entries. The cloud game application program uses a leading cloud game technology, so that a plurality of cloud games can be smoothly played through the cloud game entries without downloading games on the terminal. For example, the cloud game application program provides a plurality of cloud game entries. The player selects an entry corresponding to the cloud game A in the plurality of cloud game entries, to generate the game operation data, and the game operation data is transmitted to the cloud server. The cloud server determines the first picture data corresponding to the cloud game A based on the game operation data, and transmits the first picture data to the terminal, so that the terminal renders the first picture data to obtain the virtual scene picture.

In some embodiments, the first picture data is implemented as picture data corresponding to a game entering picture; or the first picture data is implemented as data corresponding to a game battle picture; or the first picture data is implemented as data corresponding to a game ending picture; or the like. In other words, the first picture data includes picture data corresponding to a plurality of pictures, such as a picture before the game starts, a picture during the game, and a picture after the game ends.

Operation 320: Display an effect switching region in response to that a display effect switching operation is received.

The display effect switching operation is configured for adjusting a picture display effect of the displayed virtual scene picture.

In one embodiment, the effect switching region is displayed based on the display effect switching operation, the effect switching region including at least one candidate picture display effect.

The candidate picture display effect includes at least one of an animation effect, a pixel effect, an oil painting effect, an ink effect, a black-and-white effect, a sharpen effect, and an original painting effect. The picture display effect is configured for representing picture display of the virtual scene picture. In one embodiment, the picture display effect may alternatively be referred to as a name such as a picture style or a picture filter.

The animation effect is configured for representing that the virtual scene picture is displayed as a soft and bright painting style; the pixel effect is configured for representing that the virtual scene picture is displayed as a painting style presented in a pixel form; the oil painting effect is configured for representing that the virtual scene picture is displayed as a rich, heavy, steady, and glossy painting style; the ink effect is configured for representing that the virtual scene picture is displayed as a painting style subtle in color and rich in artistic conception; the original painting effect is configured for representing that the virtual scene picture is displayed as an original painting style (for example, a preset painting style) of a virtual scene; and the like.

For example, the displayed virtual scene picture is the original painting effect, and in response to that the display effect switching operation is received, the displayed effect switching region is configured for prompting the player that the original painting effect may be adjusted to another picture display effect; or the displayed virtual scene picture is the animation effect, and in response to that the display effect switching operation is received, the displayed effect switching region is configured for prompting the player that the animation effect may be adjusted to another picture display effect.

In one embodiment, other candidate picture display effects other than a current picture display effect are displayed in the effect switching region.

For example, the current picture display effect is configured for indicating a picture display effect of a currently displayed virtual scene picture. If the picture display effect of the currently displayed virtual scene picture is the original painting effect, the displayed effect switching region does not include the original painting effect. For example, the displayed effect switching region includes the animation effect, the pixel effect, the oil painting effect, and the ink effect.

In one embodiment, a plurality of candidate picture display effects including a current picture display effect are displayed in the effect switching region.

For example, the current picture display effect is configured for indicating a picture display effect of a currently displayed virtual scene picture. If the picture display effect of the currently displayed virtual scene picture is the oil painting effect, the displayed effect switching region includes the animation effect, the pixel effect, and the ink effect other than the oil painting effect, and also includes the oil painting effect.

The foregoing descriptions are merely exemplary examples. These are not limited in the embodiments of this application.

Operation 330: Display, based on a selection operation for a first picture display effect in the at least one candidate picture display effect, the virtual scene picture having the first picture display effect.

The first picture display effect is any picture display effect selected from the at least one candidate picture display effect. For example, the at least one candidate picture display effect includes the animation effect, the pixel effect, and the ink effect. Based on a selection operation for the pixel effect, the pixel effect is the first picture display effect. In other words, the selection operation is configured for indicating an operation of selecting a picture display effect from the at least one candidate picture display effect.

The virtual scene picture having the first picture display effect is a picture obtained by rendering second picture data transmitted by the cloud server, and the second picture data is data obtained by adjusting the first picture data by using the first picture display effect by the cloud server.

For example, based on the selection operation, the terminal requests the cloud server to adjust the picture display effect of the virtual scene picture.

In one embodiment, the cloud server is configured to transmit data related to game processing to the terminal. Therefore, a cloud server end has the first picture data indicating the virtual scene picture; and based on the request transmitted by the terminal to the cloud server, the cloud server adjusts the first picture data by using the first picture display effect, to obtain the second picture data.

For example, the cloud server determines a picture adjustment strategy corresponding to the first picture display effect based on the selection operation received by the terminal, and adjusts the first picture data by using the picture adjustment strategy, to obtain the second picture data.

For example, based on a difference of the picture display effect indicated by the selection operation, the cloud server determines picture adjustment parameters corresponding to the first picture display effect, and adjusts the first picture data by using the picture adjustment parameters, to obtain the second picture data, thereby implementing a process of adjusting the first picture data by using different picture adjustment parameters.

In some embodiments, the first picture data is implemented as picture data of a virtual scene picture having the original painting effect. When the cloud server performs an operation for the first picture data based on the selection operation, the cloud server adjusts the first picture data by using the picture adjustment strategy indicated by the first picture display effect.

For example, a current virtual scene picture is the virtual scene picture having the original painting effect. During a first selection operation (selection operation 1), a first picture display effect indicated by the selection operation 1 is the pixel effect, and in this case, the virtual scene picture having the original painting effect is adjusted by using a picture adjustment strategy 1 indicated by the pixel effect. Later, during a second selection operation (selection operation 2), a first picture display effect indicated by the selection operation 2 is the ink effect, and in this case, the virtual scene picture having the original painting effect is adjusted by using a picture adjustment strategy 2 indicated by the ink effect. In other words, during the second selection operation, an object adjusted by the cloud server is not the virtual scene picture having the pixel effect but the virtual scene picture having the original painting effect.

In some embodiments, the first picture data is implemented as picture data corresponding to a current virtual scene picture, and a picture display effect of the current virtual scene picture is implemented as at least one of the animation effect, the pixel effect, the oil painting effect, the ink effect, and the original painting effect. When the cloud server performs an operation for the first picture data based on the selection operation, the cloud server adjusts the first picture data by using the picture adjustment strategy indicated by the first picture display effect.

For example, the current virtual scene picture is a virtual scene picture having the original painting effect. During a first selection operation (selection operation 1), a first picture display effect indicated by the selection operation 1 is the pixel effect, and in this case, the virtual scene picture having the original painting effect is adjusted by using a picture adjustment strategy 1 indicated by the pixel effect. Later, during a second selection operation (selection operation 2), a first picture display effect indicated by the selection operation 2 is the ink effect, and in this case, the current virtual scene picture having the pixel effect is adjusted by using a picture adjustment strategy 2 indicated by the ink effect. In other words, during the second selection operation, the cloud server does not adjust the virtual scene picture having the original painting effect, but performs an overlay-adjustment process on the picture display effect of the current virtual scene picture.

In other words, the first picture display effect is determined based on the selection operation, to further determine the picture adjustment strategy corresponding to the first picture display effect, to clarify a data transmission procedure, and avoid an error generated in the second picture data, thereby improving data obtaining accuracy.

In one embodiment, a manner in which the first picture display effect is displayed in the virtual scene picture includes at least one of the following manners:

1. The second picture data obtained by adjusting the first picture data by using the first picture display effect by the cloud server is rendered in real time, and the first picture display effect is displayed in the virtual scene picture. In other words, a presentation process of the current first picture display effect is synchronously presented as the second picture data is generated.

2. After the cloud server adjusts the first picture data by using the first picture display effect to obtain the complete second picture data, the second picture data is rendered, and the virtual scene picture having the first picture display effect is displayed. In other words, after the complete second picture data is obtained, the second picture data is rendered, and the first picture display effect is displayed.

3. After the cloud server adjusts the first picture data by using the first picture display effect to obtain second picture data of a specified data amount, the second picture data of the specified data amount is rendered, and the virtual scene picture having the first picture display effect is displayed; the first picture data is continuously and synchronously adjusted, to obtain remaining second picture data; and the remaining second picture data starts to be rendered when the rendering of the second picture data of the specified data amount is completed.

In conclusion, in a cloud game scene, a virtual scene picture of a cloud game is displayed after first picture data transmitted by a cloud server is rendered, an effect switching region is displayed after a display effect switching operation is received, and the virtual scene picture having a first picture display effect obtained by rendering second picture data transmitted by the cloud server is displayed based on a selection operation for the first picture display effect, where the second picture data is data obtained by adjusting the first picture data by using the first picture display effect by the cloud server. The cloud server is used to adjust a picture display effect of the virtual scene picture, to avoid a limitation that the picture display effect can be changed only after the picture display effect is locally downloaded. The cloud server can be used to efficiently and targetedly adjust the first picture data corresponding to the virtual scene picture, thereby improving flexibility and improving efficiency of displaying the virtual scene picture having the first picture display effect.

In an exemplary embodiment, during the selection operation, in addition to that the first picture display effect may be selected from the at least one candidate picture display effect, display effect intensity of the first picture display effect may further be adjusted. For example, as shown in FIG. 4, operation 330 shown in FIG. 3 may further be implemented as operation 410 to operation 430 described below.

Operation 410: Display an effect intensity adjustment region based on the selection operation for the first picture display effect in the at least one candidate picture display effect.

For example, the selection operation is configured for determining the first picture display effect from the at least one candidate picture display effect displayed in the effect switching region, and the effect switching region is configured for representing a region in which the at least one candidate picture effect is presented.

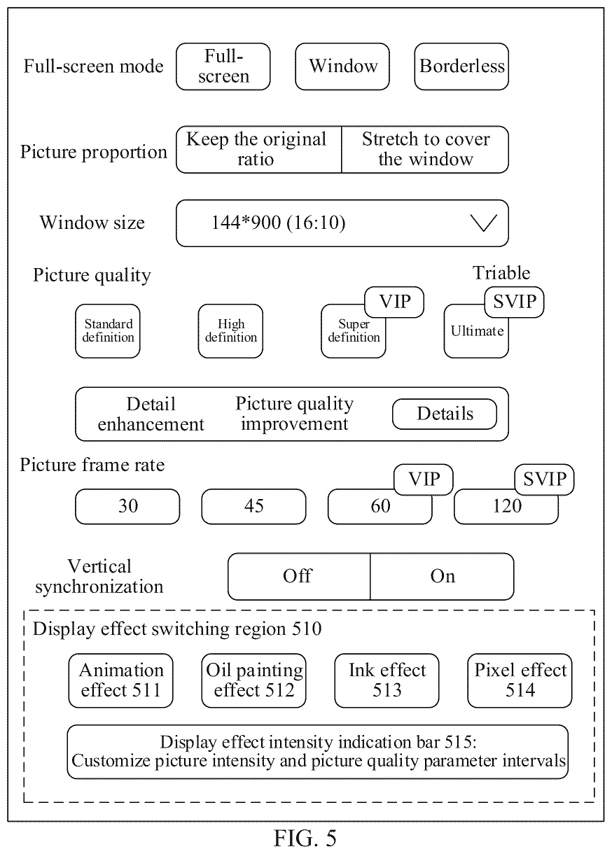

FIG. 5 is a schematic diagram of an interface of a functional region. A plurality of functional regions are included. Different functional regions are configured for implementing different functions. The plurality of functional regions include an effect switching region 510. The effect switching region corresponds to a display effect switching function, and is configured for adjusting the picture display effect of the current virtual scene picture.

As shown in FIG. 5, the effect switching region 510 includes a plurality of candidate picture display effects: an animation effect 511, an oil painting effect 512, an ink effect 513, and a pixel effect 514. The player may manually select a picture display effect that the player intends to try, such as the animation effect 511, the oil painting effect 512, the ink effect 513, or the pixel effect 514. For example, each time a specified picture display effect is switched, a game picture instantly changes.

For example, the effect switching region 510 further includes a display effect intensity indication bar 515, configured for indicating that picture intensity and picture quality parameter intervals may be customized.

In some embodiments, the effect intensity adjustment region is displayed based on the selection operation.

In other words, the displayed effect intensity adjustment region is configured for adjusting the display effect intensity of the first picture display effect determined based on the selection operation.

In one embodiment, as shown in FIG. 5, based on the selection operation, the display effect intensity indication bar 515 is associated with the first picture display effect determined based on the selection operation, so that the effect intensity adjustment region is displayed at the display effect intensity indication bar 515.

In one embodiment, the effect intensity adjustment region is overlay-displayed on the virtual scene picture based on the selection operation.

The effect intensity adjustment region is configured for adjusting the display effect intensity of the first picture display effect, and the display effect intensity is configured for representing a visual effect of the picture display effect.

In one embodiment, a property of the display effect intensity may be pre-configured. For example, higher display effect intensity indicates a stronger picture sharpen effect; or higher display effect intensity indicates a stronger comparison effect between the first picture display effect and the original painting effect.

For example, as shown in FIG. 5, after a selection operation is performed for any picture display effect in the effect switching region 510, the effect intensity adjustment region is displayed.

Operation 420: Receive an adjustment operation in the effect intensity adjustment region.

The adjustment operation is configured for adjusting the display effect intensity to first display effect intensity under the first picture display effect, the display effect intensity is visual intensity of the picture display effect, and the first display effect intensity is configured for indicating display effect intensity selected by the player.

In one embodiment, the selection operation is implemented in an operation form such as a click operation or a long-press operation. For example, after the player determines the specified picture display effect and performs a click operation for the picture display effect, the picture display effect is used as the first picture display effect, and a display adjustment operation is displayed under the first picture display effect.

In an exemplary embodiment, the effect intensity adjustment region includes a display effect intensity adjustment slot.

The display effect intensity adjustment slot is configured to adjust the display effect intensity of the picture display effect.

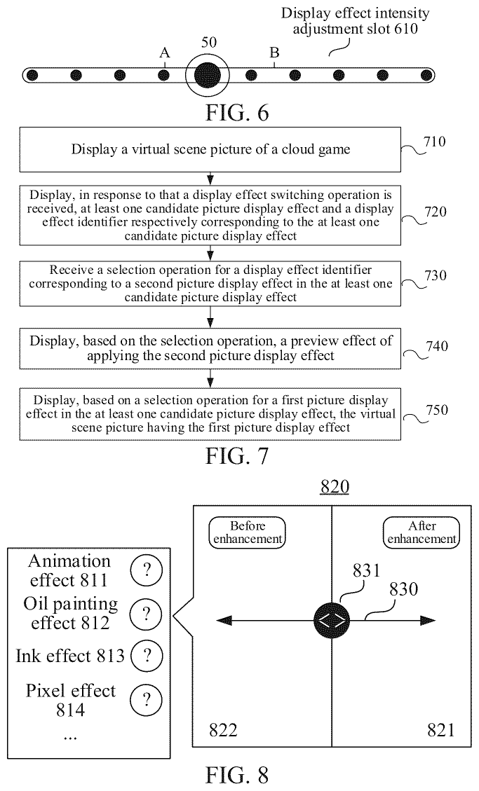

For example, after the selection operation is performed, an effect intensity adjustment region shown in FIG. 6 is displayed, where the effect intensity adjustment region includes a display effect intensity adjustment slot 610.

In some embodiments, a slide operation for the display effect intensity adjustment slot is received as the display adjustment operation.

For example, as shown in FIG. 6, the player adjusts the display effect intensity of the first picture display effect through a slide operation for the display effect intensity adjustment slot 610; when the player slides leftward in the display effect intensity adjustment slot 610, the display effect intensity of the first picture display effect is weakened; and when the player slides rightward in the display effect intensity adjustment slot 610, the display effect intensity of the first picture display effect is enhanced.

In one embodiment, each time a parameter on the display effect intensity adjustment slot corresponding to the first picture display effect is adjusted, the game picture instantly changes.

In some embodiments, a click operation for the display effect intensity adjustment slot is received as the display adjustment operation.

For example, as shown in FIG. 6, when the display effect intensity adjustment slot 610 is displayed, the player may directly click on the display effect intensity adjustment slot 610, to select corresponding display effect intensity. For example, when a point A in the display effect intensity adjustment slot 610 is clicked on, the display effect intensity is 40; or when a point B in the display effect intensity adjustment slot 610 is clicked on, the display effect intensity is 65.

In other words, the effect intensity adjustment region is implemented as the effect intensity adjustment slot, and different types of operations are used as the adjustment operation for the display effect intensity, so that a process of the display effect intensity can be concretely represented, thereby improving accuracy of effect intensity adjustment by player.

In an exemplary embodiment, the display effect intensity adjustment slot includes a plurality of display effect intensity selection points.

For example, as shown in FIG. 6, the displayed display effect intensity adjustment slot 610 includes a plurality of display effect intensity selection points, the display effect intensity selection points being configured for distinguishing different display effect intensity.

In one embodiment, a click operation for a display effect intensity selection point corresponding to the first display effect intensity in the display effect intensity adjustment slot is received as the display adjustment operation.

In some embodiments, default display effect intensity is labeled in the effect intensity adjustment region based on the selection operation for the first picture display effect in the at least one candidate picture display effect; and the display adjustment operation in the effect intensity adjustment region is received, and the default display effect intensity is adjusted to the first display effect intensity.

For example, as shown in FIG. 6, default display effect intensity is labeled as 50 in the effect intensity adjustment region displayed based on the selection operation. Subsequently, based on the display adjustment operation, such as a slide operation, of the player in the effect intensity adjustment region, the default display effect intensity is adjusted to the first display effect intensity. For example, the first display effect intensity is 60.

In other words, the plurality of effect intensity selection points configured for distinguishing different display effect intensity are arranged in the effect intensity adjustment slot, so that the player can directly select different effect intensity selection points to implement a process of adjusting the display effect intensity, thereby improving efficiency of human-computer interaction, and improving efficiency of adjusting the display effect intensity by the player.

Operation 430: Display the virtual scene picture having the first picture display effect in which the first picture display effect corresponds to the first display effect intensity.

For example, after the first picture display effect and the first display effect intensity corresponding to the first picture display effect are determined, the cloud server applies the first picture display effect having the first display effect intensity to the virtual scene picture, to generate the second picture data.

For example, after the second picture data is generated, the cloud server transmits the second picture data to the terminal. The terminal renders the second picture data, and displays the virtual scene picture having the first picture display effect in which the first picture display effect corresponds to the first display effect intensity.

In one embodiment, through adjustment of a picture display effect, replayability of an old-version game can be improved to some extent, and game playability can be improved; and a display effect of a game picture is changed by using different picture display effects autonomously selected by a player, and a picture display effect selected by the player is customized by using a process in which the player adjusts various picture quality parameters, thereby improving sustainability and development potential of the old-version game.

In an exemplary embodiment, an interest display effect for the first picture display effect and the display effect intensity is generated based on the selection operation and the display adjustment operation; and in response to displaying a same virtual scene interface, the interest display effect is displayed in the effect switching region as a candidate picture display effect.

For example, a first picture display effect selected by the player on a virtual scene interface A is the ink effect, display effect intensity corresponding to the ink effect is 80, and an interest display effect is generated based on the ink effect and the display effect intensity 80; and when a virtual scene interface displayed in the game of the player is changed to the virtual scene interface A again, if the player determines to adjust the picture display effect again, the interest display effect (the ink effect with the display effect intensity 80) is displayed in the effect switching region; or when a virtual scene interface displayed in a game of another player is changed to the virtual scene interface A, if the player determines to adjust the picture display effect, an interest display effect (the ink effect with the display effect intensity 80) of the another player is displayed in the effect switching region. In this way, it is beneficial to subsequently iterating new filters according to tastes of players, thereby bringing new audiences and markets to the game.

In the embodiments of this application, the following content is introduced: In addition to that the first picture display effect is selected through the selection operation, the display effect intensity corresponding to the first picture display effect is adjusted by using the effect intensity adjustment region, so that when the cloud server adjusts the first picture data based on the first picture display effect, the cloud server adjusts the first picture data more comprehensively by using the first picture display effect and the display effect intensity corresponding to the first picture display effect, so that the terminal can implement a process of flexibly displaying the virtual scene picture having different display effect intensity based on the second picture data transmitted by the cloud server, thereby greatly improving a degree of freedom and participation of the player.

In an exemplary embodiment, in addition to that the displayed effect switching region includes the at least one candidate picture display effect, each candidate picture display effect further corresponds to a display effect identifier. An effect of the candidate picture display effect can be previewed through the display effect identifier. For example, as shown in FIG. 7, the embodiment shown in FIG. 3 may alternatively be implemented as operation 710 to operation 750 described below.

Operation 710: Display a virtual scene picture of a cloud game.

The virtual scene picture is a picture obtained by rendering first picture data transmitted by a cloud server.

Operation 710 has been described in operation 210 described above. Details are not described herein again.

Operation 720: Display, in response to that a display effect switching operation is received, at least one candidate picture display effect and a display effect identifier respectively corresponding to the at least one candidate picture display effect.

For example, the display effect switching operation is configured for displaying the candidate picture display effect. In one embodiment, a functional display control is displayed on the virtual scene picture, and an effect switching region including the candidate picture display effect is displayed based on a trigger operation for the functional display control.

In one embodiment, the at least one candidate picture display effect and the display effect identifier respectively corresponding to the at least one candidate picture display effect are displayed in the effect switching region. In other words, the effect switching region includes the at least one candidate picture display effect, and the picture display effect is configured for representing picture display of the virtual scene picture.

FIG. 8 is a schematic diagram of an interface of an exemplary effect switching region. The effect switching region includes a plurality of candidate picture display effects: an animation effect 811, an oil painting effect 812, an ink effect 813, and a pixel effect 814. Each candidate picture display effect includes a display effect identifier, which is represented on the right side of the corresponding candidate picture display effect in a form of an identifier “?” in FIG. 8.

The display effect identifier is configured for previewing an effect of applying the candidate picture display effect.

For example, after a display effect identifier corresponding to the animation effect 811 is selected, an effect of applying the animation effect 811 can be previewed; and after a display effect identifier corresponding to the oil painting effect 812 is selected, an effect of applying the oil painting effect 812 can be previewed.

In other words, based on displaying the candidate picture display effect, the corresponding effect identifier is additionally displayed, so that a player can learn the candidate picture display effect in advance through the display effect identifier, thereby improving accuracy of selecting the candidate picture display effect subsequently.

Operation 730: Receive a selection operation for a display effect identifier corresponding to a second picture display effect in the at least one candidate picture display effect.

The second picture display effect is any picture display effect in the at least one candidate picture display effect.

For example, different candidate picture display effects respectively have display effect identifiers corresponding to the different candidate picture display effects. Therefore, a selection operation may be performed for a display effect identifier corresponding to a candidate picture display effect, where the selection operation is configured for indicating to apply the candidate picture display effect.

In an exemplary embodiment, a stay operation for the display effect identifier is received as the selection operation.

For example, as shown in FIG. 8, description is made by using an example in which the second picture display effect is implemented as the oil painting effect 812. The display effect identifier corresponding to the oil painting effect 812 is determined, and a stay operation for the display effect identifier is used as the selection operation.

For example, the schematic diagram of the effect switching region shown in FIG. 8 is a schematic diagram of a computer end, and a stay operation of a mouse device for the display effect identifier is used as the selection operation for the display effect identifier corresponding to the picture display effect.

In one embodiment, the stay operation corresponds to trigger duration, where the trigger duration is configured for representing duration for implementing the stay operation. For example, the trigger duration corresponding to the stay operation is 1 s; or the trigger duration corresponding to the stay operation is 1.5 s.

In an exemplary embodiment, a click operation for the display effect identifier is received as the selection operation.

For example, as shown in FIG. 8, description is made by using an example in which the second picture display effect is implemented as the oil painting effect 812. The display effect identifier corresponding to the oil painting effect 812 is determined, and a click operation for the display effect identifier is used as the selection operation.

For example, the schematic diagram of the effect switching region shown in FIG. 8 is a schematic diagram of a computer end, and a click operation of a mouse device for the display effect identifier is used as the selection operation for the display effect identifier corresponding to the picture display effect; or the schematic diagram of the effect switching region shown in FIG. 8 is a schematic diagram of a mobile phone end, and a click operation of a player finger for the display effect identifier is used as the selection operation for the display effect identifier corresponding to the picture display effect. The click operation is implemented in a plurality of forms such as a one-click operation and a double-click operation.

In some embodiments, a long-press operation for the display effect identifier is received as the selection operation; or a slide right operation for the display effect identifier is received as the selection operation; or in response to that a speech trigger instruction is received, a trigger operation corresponding to the speech trigger instruction is used as the selection operation, for example, the speech trigger instruction is “View a preview effect of the oil painting effect 812”.

The foregoing trigger manners are merely exemplary examples. These are not limited in the embodiments of this application.

Operation 740: Display, based on the selection operation, a preview effect of applying the second picture display effect.

In an exemplary embodiment, the preview effect of applying the second picture display effect to a current virtual scene picture is displayed based on the selection operation.

For example, after the display effect identifier corresponding to the second picture display effect is selected based on the selection operation, the second picture display effect is applied to the current virtual scene picture.

For example, the current virtual scene picture is a virtual battle picture, and the second picture display effect is the oil painting effect. After the display effect identifier corresponding to the oil painting effect is selected, the oil painting effect is applied to the current virtual battle picture, to convert the current virtual battle picture into a rich, heavy, steady, and glossy oil painting effect.

Alternatively, the current virtual scene picture is a battle starting picture, and the second picture display effect is the ink effect. After the display effect identifier corresponding to the ink effect is selected, the ink effect is applied to the current battle starting picture, to convert the current battle starting picture into the ink effect subtle in color and rich in artistic conception.

In other words, after the selection operation is triggered, the second picture display effect is applied to the current virtual scene picture according to a picture situation of the current virtual scene picture when the selection operation is triggered, so that the preview effect obtained by applying the second picture display effect is different as the current virtual scene picture have different pictures.

In an exemplary embodiment, the preview effect of applying the second picture display effect to a preset virtual scene picture is displayed based on the selection operation.

For example, after the display effect identifier corresponding to the second picture display effect is selected based on the selection operation, the second picture display effect is applied to the preset virtual scene picture. The preset virtual scene picture is a virtual scene picture that is preset. For example, the preset virtual scene picture is a battle starting picture; or the preset virtual scene picture is a virtual battle picture on which a virtual object A and a virtual object B perform a virtual battle at a virtual location C.

For example, the preset virtual scene picture is the battle starting picture, the virtual scene picture when the selection operation is triggered is a virtual battle picture, and the selected second picture display effect is the oil painting effect. After the display effect identifier corresponding to the oil painting effect is selected, the oil painting effect is applied to the preset battle starting picture, to convert the preset battle starting picture into a rich, heavy, steady, and glossy oil painting effect.

In other words, after the selection operation is triggered, the second picture display effect is directly applied to the preset virtual scene picture, to preview an application comparison effect of the second picture display effect more quickly.

In an exemplary embodiment, a preview effect window is overlay-displayed on the virtual scene picture based on the selection operation.

A comparison effect of not applying the second picture display effect is displayed on a first side of the preview effect window, and the preview effect of applying the second picture display effect is displayed on a second side of the preview effect window.

For example, as shown in FIG. 8, an example in which the second picture display effect is the oil painting effect 812 is used. Based on the selection operation for the display effect identifier corresponding to the oil painting effect 812, a preview effect window 820 is overlay-displayed on the virtual scene picture. The preview effect window 820 includes a preview effect 821 after the oil painting effect 812 is applied (a first side, after enhancement), and a comparison effect 822 before the oil painting effect 812 is applied (a second side, before enhancement).

In other words, the preview effect and the comparison effect are added in the preview effect window, so that comparison situation between before and after the second picture display effect is applied can be presented more vividly, thereby improving accuracy of selecting the corresponding picture display effect by the player.

In an exemplary embodiment, the selection operation may be performed for a display effect identifier of one second picture display effect, or may be performed for display effect identifiers of a plurality of second picture display effects.

For example, when the display effect identifier of the one second picture display effect is selected, the selection operation is implemented by performing a stay operation, a click operation, or the like for the display effect identifier of the second picture display effect.

For example, when the display effect identifiers of the plurality of second picture display effects are selected, the selection operation is implemented by performing a long-press selection operation, a long-press check operation, a double-click check operation, or the like for the display effect identifiers respectively corresponding to the plurality of second picture display effects.

In one embodiment, in response to that the display effect identifier of the one second picture display effect is selected, the comparison effect of not applying the second picture display effect is displayed on the first side of the preview effect window, and the preview effect of applying the second picture display effect is displayed on the second side of the preview effect window.

In one embodiment, in response to that the display effect identifiers of the plurality of second picture display effects are selected, the comparison effect and preview effects respectively corresponding to applying the plurality of second picture display effects are displayed in the preview effect window.

For example, the comparison effect of not applying the second picture display effect is displayed on the first side of the preview effect window, and the preview effects respectively corresponding to applying the plurality of second picture display effects are displayed on the second side of the preview effect window. For example, if selection is performed for display effect identifiers of three second picture display effects, three preview effects are included on the second side.

The first side and the second side described above are merely exemplary examples. A region area of the first side and a region area of the second side may be the same, may be different, or the like. These are not limited in the embodiments of this application.

In some embodiments, the preview effect window includes a display effect intensity preview slot.

The display effect intensity preview slot is configured to present preview effects of different display effect intensity, and display effect intensity is configured for representing a visual effect of a picture display effect.

For example, as shown in FIG. 8, in addition to the preview effect 821 and the comparison effect 822, the displayed preview effect window 820 further includes a display effect intensity preview slot 830. Preview effects of different display effect intensity in the preview effect 821 may be adjusted through an adjustment operation for the display effect intensity preview slot 830.

In an exemplary embodiment, a slide operation for the display effect intensity preview slot is received.

In one embodiment, the display effect intensity preview slot includes a display effect intensity adjustment control, and the slide operation for the display effect intensity preview slot is implemented by triggering movement of the display effect intensity adjustment control in the display effect intensity preview slot.

As shown in FIG. 8, the display effect intensity preview slot 830 includes a display effect intensity adjustment control 831, and an arrow identifier in the display effect intensity adjustment control 831 indicates movement in a left-right direction. In other words, a slide operation for the display effect intensity preview slot 830 is implemented by moving the display effect intensity adjustment control 831 in the left-right direction.

For example, the display effect intensity adjustment control 831 shown in FIG. 8 is slid leftward in the display effect intensity preview slot 830, to implement a process of weakening the display effect intensity; or the display effect intensity adjustment control 831 shown in FIG. 8 is slid right in the display effect intensity preview slot 830, to implement a process of enhancing the display effect intensity.

In an exemplary embodiment, when the slide operation indicates second display effect intensity, the preview effect of applying the second picture display effect in which the second picture display effect corresponds to the second display effect intensity is displayed in the preview effect window.

For example, the second display effect intensity is display effect intensity selected by the player. When the slide operation indicates the second display effect intensity, it indicates that a picture having the second display effect intensity under the second picture display effect needs to be previewed. As shown in FIG. 8, when the slide operation indicates the second display effect intensity, the preview effect 821 of applying the second picture display effect and having the second display effect intensity is displayed in the preview effect window 820.

In one embodiment, a property of the display effect intensity may be pre-configured. For example, higher display effect intensity indicates a stronger picture sharpen effect; or higher display effect intensity indicates a stronger comparison effect between the second picture display effect and the original painting effect.

In other words, the effect intensity preview slot is added in the preview effect window, so that preview effects corresponding to different display effect intensity of the picture display effect can be directly presented through the slide operation. In this way, efficiency of human-computer interaction is improved, and a matching degree between a picture display effect subsequently selected by the player and expectation of the player can further be improved.

In other words, the preview effect of applying the second picture display effect in the virtual scene picture is displayed through the selection operation for the display effect identifier corresponding to the second picture display effect. In this way, through addition of presentation of preview effects, comprehensiveness of presenting different picture display effects to the player can be improved, thereby improving the matching degree that the picture display effect selected by the player meets the expectation.

Operation 750: Display, based on a selection operation for a first picture display effect in the at least one candidate picture display effect, the virtual scene picture having the first picture display effect.

The virtual scene picture having the first picture display effect is a picture obtained by rendering second picture data transmitted by the cloud server. The second picture data is data obtained by adjusting the first picture data by using the first picture display effect by the cloud server.

For example, based on the selection operation, a terminal requests the cloud server to adjust the picture display effect of the virtual scene picture.

In one embodiment, a cloud server end has the first picture data indicating the virtual scene picture; and based on the request transmitted by the terminal to the cloud server, the cloud server adjusts the first picture data by using the first picture display effect, to obtain the second picture data.

In some embodiments, the cloud server determines a picture adjustment strategy corresponding to the first picture display effect based on the selection operation received by the terminal, and adjusts the first picture data by using the picture adjustment strategy, to obtain the second picture data.

For example, based on a difference of the picture display effect indicated by the selection operation, the cloud server determines picture adjustment parameters corresponding to the first picture display effect, and adjusts the first picture data by using the picture adjustment parameters, to obtain the second picture data, thereby implementing a process of adjusting the first picture data by using different picture adjustment parameters.

In conclusion, a cloud server is used to adjust a picture display effect of a virtual scene picture, to avoid a limitation that the picture display effect can be changed only after the picture display effect is locally downloaded. The cloud server can be used to efficiently and targetedly adjust first picture data corresponding to the virtual scene picture, thereby improving flexibility and improving efficiency of displaying the virtual scene picture having a first picture display effect.

In the embodiments of this application, the content in which a picture display effect is previewed by using a display effect identifier corresponding to a candidate picture display effect is introduced. Through the selection operation for the display effect identifier corresponding to the second picture display effect, the preview effect of applying the second picture display effect can be displayed, to avoid the complex problem that an application effect can be learned only after the picture display effect is applied. Through the preview effect, the player can be assisted in learning the application of the second picture display effect more quickly. This is beneficial to improving interestingness of the player in selecting the picture display effect, and also beneficial to improving the efficiency of human-computer interaction.

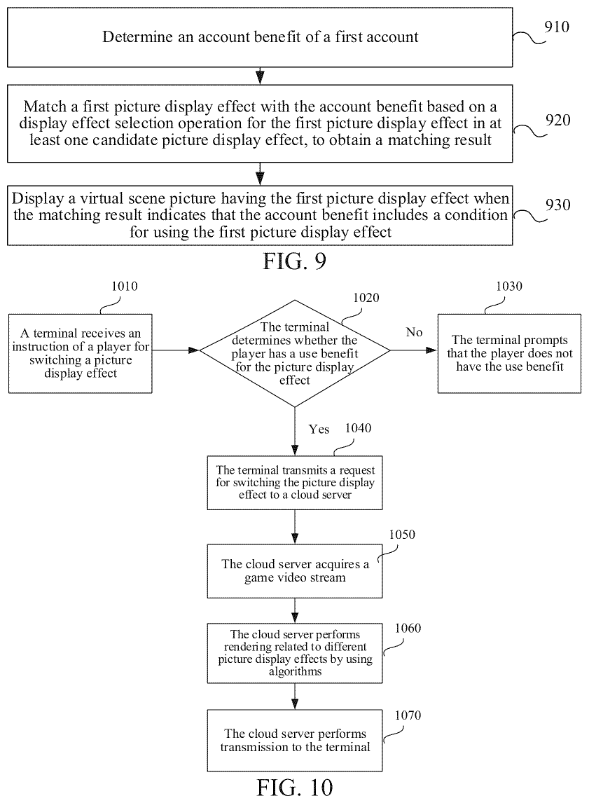

In an exemplary embodiment, the method for displaying a virtual scene picture is applied to a terminal. A first account is logged in to the terminal, and a process of displaying the virtual scene picture is determined according to an account benefit of the first account. For example, as shown in FIG. 9, the embodiment shown in FIG. 3 may alternatively be implemented as operation 910 to operation 930 described below.

Operation 910: Determine the account benefit of the first account.

The account benefit includes an application condition of the first account for a candidate picture display effect.

For example, the account benefit is implemented as an account level of the first account, for example, the account level is level 1, level 5, level 10, or the like; and/or the account benefit is implemented as account permission of the first account, for example, the account permission is an ordinary account, a very important person (VIP) account, a super very important person (SVIP) account, or the like.

In one embodiment, when the account benefit of the first account is determined, at least one of the account level and the account permission of the first account is determined. For example, the account benefit of the first account is a level-12 account and the VIP account; or the account benefit of the first account is the VIP account.

In some embodiments, at least one candidate picture display effect each corresponds to one application condition. For example, the candidate picture display effects include a pixel effect and an ink effect, where an application condition for the pixel effect is the ordinary account, in other words, the ordinary account and the account permission above the ordinary account may use the pixel effect; and an application condition of the ink effect is the SVIP account, in other words, the SVIP account and the account permission above the SVIP account may use the ink effect.

Operation 920: Match a first picture display effect with the account benefit based on a selection operation for the first picture display effect in the at least one candidate picture display effect, to obtain a matching result.

The first picture display effect is a picture display effect selected from the at least one candidate picture display effect. For example, after the selection operation for the first picture display effect is received, the first picture display effect is matched with the account benefit of the first account, in other words, whether the first account can use the first picture display effect is determined according to the account benefit of the first account.

In one embodiment, the matching result includes the following cases.

(1) According to the account benefit of the first account, it is determined that the first account can use the first picture display effect.

For example, an application condition for the first picture display effect is that the VIP account can use the first picture display effect. If the account benefit of the first account is the VIP account, it is determined that the first account can use the first picture display effect.

(2) According to the account benefit of the first account, it is determined that the first account cannot use the first picture display effect.

For example, an application condition for the first picture display effect is that the SVIP account can use the first picture display effect. If the account benefit of the first account is the VIP account, it is determined that the first account cannot use the first picture display effect.

The application condition for the first picture display effect may alternatively be set by using the account level, the application condition for the first picture display effect may alternatively be set by using both the account level and the account permission, or the like. The foregoing descriptions are merely exemplary examples. These are not limited in the embodiments of this application.

In an exemplary embodiment, the first picture display effect further corresponds to display effect intensity. When the matching result is obtained by matching the first picture display effect with the account benefit, in addition to that a comparison situation between the account benefit and the first picture display effect is determined, a comparison situation between the account benefit and the display effect intensity corresponding to the first picture display effect is further determined.

In one embodiment, the matching result alternatively includes the following cases.

(1) According to the account benefit of the first account, it is determined that the first account can use the first picture display effect and the first account can use the display effect intensity corresponding to the first picture display effect.

For example, an application condition for the first picture display effect is that the VIP account can use the first picture display effect and any display effect intensity corresponding to the first picture display effect. If the account benefit of the first account is the VIP account, it is determined that the first account can use the first picture display effect and can also use the display effect intensity corresponding to the first picture display effect.

(2) According to the account benefit of the first account, it is determined that the first account can use the first picture display effect but cannot use the display effect intensity corresponding to the first picture display effect.

For example, an application condition for the first picture display effect is that the VIP account can use the first picture display effect and the SVIP account can use any display effect intensity corresponding to the first picture display effect. If the account benefit of the first account is the VIP account, it is determined that the first account can use the first picture display effect but cannot use the display effect intensity corresponding to the first picture display effect. Alternatively, the application condition for the first picture display effect is that the VIP account can use the first picture display effect, the VIP account can use display effect intensity of 0 to 60 corresponding to the first picture display effect, and the SVIP account can use display effect intensity of 61 to 100 corresponding to the first picture display effect. If the account benefit of the first account is the VIP account, it is determined that the first account can use the first picture display effect and can also use the display effect intensity of 0 to 60 corresponding to the first picture display effect, but cannot use the display effect intensity of 61 to 100 corresponding to the first picture display effect.

Operation 930: Display a virtual scene picture having the first picture display effect when the matching result indicates that the account benefit includes a condition for using the first picture display effect.

For example, the matching result indicates that the account benefit includes the condition for using the first picture display effect, in other words, according to the account benefit of the first account, it is determined that the first account can use the first picture display effect. In this case, the terminal corresponding to the first account displays the virtual scene picture having the first picture display effect.

In an exemplary embodiment, if the matching result indicates that the account benefit includes the condition for using the first picture display effect, a picture display effect application request is transmitted to a cloud server.

The picture display effect application request is configured for indicating the cloud server to apply the first picture display effect to the virtual scene picture.

For example, the process of determining, according to the account benefit of the first account, whether the first account can use the first picture display effect is information determined by the terminal. When the terminal determines that the first account can use the first picture display effect, the terminal transmits the picture display effect application request to the cloud server, to request the cloud server to apply the first picture display effect to the virtual scene picture.

In other words, the process of applying the picture display effect is a process completed by the cloud server.

In an exemplary embodiment, second picture data transmitted by the cloud server is received. The second picture data is data obtained by applying the first picture display effect to the virtual scene picture. For example, after the picture display effect application request is received, if the cloud server determines that the terminal has a qualification for applying the first picture display effect, the cloud server transmits the second picture data obtained by applying the first picture display effect to the virtual scene picture to the terminal.

In one embodiment, the virtual scene picture having the first picture display effect is displayed based on the second picture data.

For example, after the second picture data is received, the terminal performs the data rendering process, so that the terminal displays the virtual scene picture having the first picture display effect, thereby completing a process of converting the picture display effect.

In other words, when it is determined that the account benefit matches with the condition for the first picture display effect, the picture display effect application request is transmitted to the cloud server, so that excessive invalid requests can be prevented from being transmitted to the cloud server, thereby reducing data transmission costs.

In conclusion, a cloud server is used to adjust a picture display effect of a virtual scene picture, to avoid a limitation that the picture display effect can be changed only after the picture display effect is locally downloaded. The cloud server can be used to efficiently and targetedly adjust first picture data corresponding to the virtual scene picture, thereby improving flexibility and improving efficiency of displaying the virtual scene picture having a first picture display effect.

In the embodiments of this application, the content of determining, by using a difference of the account benefit of the first account, whether to apply the first picture display effect is introduced. When the terminal determines that the account benefit of the first account can use the first picture display effect, the terminal requests the cloud server to implement a process of applying the first picture display effect. In this way, a data occupation problem that the first picture display effect is directly downloaded but cannot be applied is avoided, and the application of the first picture display effect can also be widely promoted, thereby expanding an audience range of the benefit.

In an exemplary embodiment, the method for displaying a virtual scene picture is referred to as “a method for designing an innovative differential picture display effect in a cloud game”. The method is implemented through interaction between the terminal and the cloud server. The terminal is configured to receive a game operation of the player and transmit a request to the cloud server. FIG. 10 is a flowchart of an overall technology of a method for displaying a virtual scene picture.

Operation 1010: A terminal receives an instruction of a player for switching a picture display effect.

The picture display effect may also be referred to as a picture style. In other words, the terminal receives an instruction of the player for switching the picture style. For example, the terminal receives an instruction of the player for switching an original painting effect (or referred to as an original painting style) to a pixel effect (or referred to as a pixel style).

For example, the terminal receives a selection operation of the player for a first picture display effect in an effect switching region, and uses the selection operation as the instruction of the player for switching the picture display effect.

In one embodiment, the player selects, on the terminal, the to-be-used first picture display effect through the effect switching region, and may further select display effect intensity corresponding to the first picture display effect through an effect intensity adjustment region.

For example, an intensity parameter set corresponding to the display effect intensity is determined according to the display effect intensity corresponding to the first picture display effect, where the intensity parameter set is configured for representing parameter content related to adjusting the display effect intensity.

Operation 1020: The terminal determines whether the player has a use benefit for the picture display effect.

For example, the terminal first determines an account benefit of a first account corresponding to the player, and determines, according to an application condition corresponding to the picture display effect, whether the player has the use benefit for the picture display effect. For example, if the first account corresponding to the player is a VIP account, and the application condition corresponding to the picture display effect is that the VIP account can use the picture display effect, it is determined that the player has the use benefit for the picture display effect.

In one embodiment, when the terminal determines that the player does not have the use benefit for the first picture display effect (if no), the terminal performs the following operation 1030; or when the terminal determines that the player has the use benefit for the first picture display effect (if yes), the terminal notifies a cloud server of the first picture display effect and the intensity parameter set of the display effect intensity corresponding to the first picture display effect, and performs the following operation 1040.

Operation 1030: The terminal prompts that the player does not have the use benefit.

For example, when the terminal determines that the player does not have the use benefit for the first picture display effect, the terminal prompts that the player does not have the use benefit, and ends the procedure.

Operation 1040: The terminal transmits a request for switching the picture display effect to the cloud server.

For example, when the terminal determines that the player has the use benefit for the first picture display effect, the terminal transmits, to the cloud server, request information for requesting to switch the picture display effect.

Operation 1050: The cloud server acquires a game video stream.

For example, after the request information transmitted by the terminal is received, the cloud server acquires the game video stream based on the request information. For example, the game video stream that currently needs to be transmitted to the terminal is acquired based on the request information; or the game video stream that needs to be transmitted to the terminal at a next moment is acquired based on the request information.

Operation 1060: The cloud server performs rendering related to different picture display effects by using algorithms.

In an exemplary embodiment, the cloud server is further configured to determine the first picture display effect based on the selection operation; determine a picture adjustment strategy corresponding to the first picture display effect, the picture adjustment strategy being configured for adjusting the first picture data by using the picture display effect and obtaining second picture data; and transmit the second picture data.

For example, after the game video stream is obtained, the cloud server performs a rendering process related to the picture display effect by using the first picture display effect and the intensity parameter set of the display effect intensity corresponding to the first picture display effect transmitted by the terminal, and an algorithm configured for presenting the first picture display effect.

In some embodiments, different picture display effects correspond to different algorithms, which are also referred to as picture adjustment strategies. When the cloud server performs the rendering process based on the picture display effect, the cloud server determines the algorithm corresponding to the picture display effect, and implements the rendering process related to the picture display effect by using the algorithm.

In an exemplary embodiment, the cloud server is further configured to obtain a video image frame sequence.

The video image frame sequence includes a plurality of image frames starting at a current moment.

In some embodiments, the cloud server performs image processing on the video image frame sequence by using the picture adjustment strategy corresponding to the first picture display effect, to obtain a processed video image frame sequence.

In some embodiments, the processed video image frame sequence is encoded based on a sequence order corresponding to the video image frame sequence, to obtain the second picture data.

For example, after each frame of image in the game video stream is obtained, the cloud server performs image processing on each frame of image, where an image processing algorithm is the algorithm corresponding to the first picture display effect, and algorithm parameters are the intensity parameter set of the display effect intensity corresponding to the first picture display effect.

In one embodiment, description is made by using an example in which the first picture display effect is a black-and-white effect.

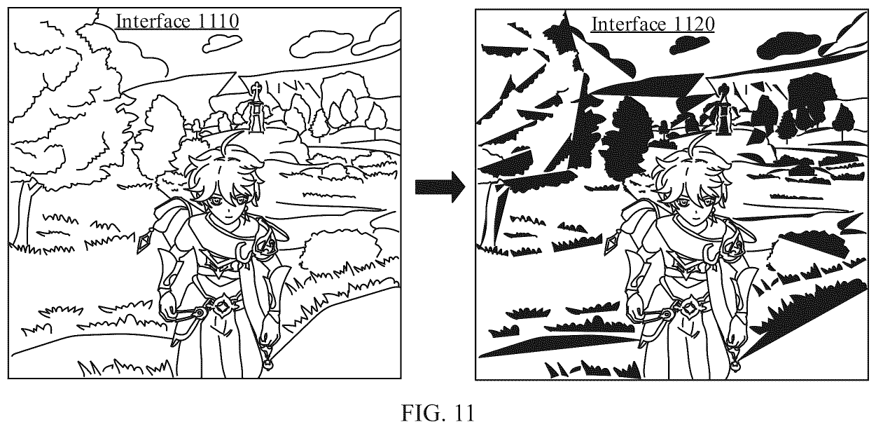

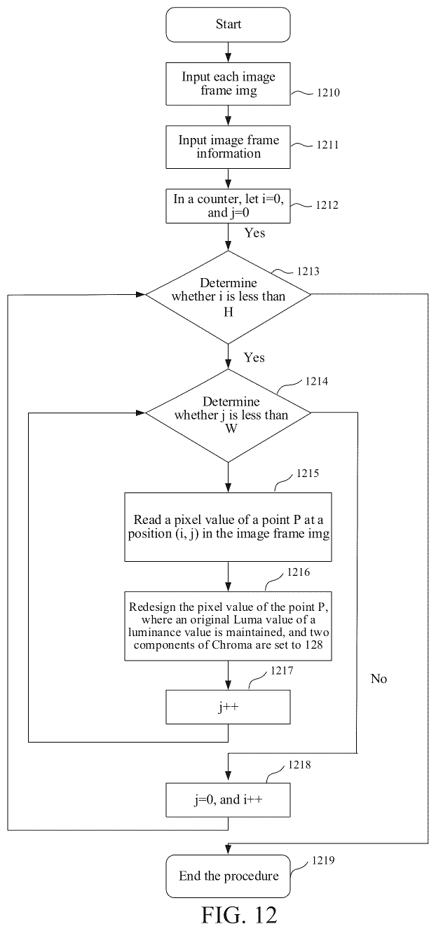

FIG. 11 is a schematic diagram of an interface of performing black-and-white effect conversion on a virtual scene picture. An interface 1110 is the virtual scene picture. If the first picture display effect is the black-and-white effect (a black-and-white filter), an interface 1120 is obtained. A procedure of an algorithm of the process is shown in FIG. 12. FIG. 12 is a flowchart of an algorithm performed by a cloud server during black-and-white effect conversion.

Operation 1210: Input each image frame img.

For example, after the cloud server acquires image frames of the game video stream, the cloud server defines a single image frame as img, and inputs each image frame img in the game video stream into an algorithm corresponding to the black-and-white effect. The cloud server processes each image frame, to obtain a black-and-white effect frame corresponding to each image frame.

In one embodiment, the black-and-white effect correspondingly includes at least one of the following algorithms:

1. Average method: A grayscale value is obtained by calculating an average value of a red (R) component, a green (G) component, and a blue (B) component of pixels in an image frame.

2. Weighted average method: Different weights are given to the R component, the G component, and the B component according to different sensitivity to different colors, and then a grayscale value is obtained by calculating a weighted average value, thereby achieving the black-and-white effect.

In one embodiment, an algorithm of the black-and-white effect corresponding to each image frame is the same; or the algorithm of the black-and-white effect corresponding to each image frame is different. This is not limited.

Operation 1211: Input image frame information.

For example, size information corresponding to each image frame img in the game video stream is inputted into the algorithm corresponding to the black-and-white effect.

The size information includes: a width corresponding to the image frame, which is denoted as W; and a height corresponding to the image frame, which is denoted as H.

Operation 1212: In a counter, let i=0, and j=0.

In the process of performing image processing on the image frame by using the algorithm corresponding to the black-and-white effect, the algorithm includes the counter, configured to perform value measurement on inputted data.

The counter includes two parameters: i and j, where i is configured for measuring the height H, and j is configured for measuring the width W.

Operation 1213: Determine whether i is less than H.

If i is less than H, operation 1214 is performed. Otherwise, all pixels of the image frame are processed, and operation 1219 is performed.

Operation 1214: Determine whether j is less than W.

If j is less than W, operation 1215 is performed. Otherwise, operation 1218 is performed.

Operation 1215: Read a pixel value of a point P at a position (i, j) in the image frame img.

Each image frame includes a plurality of pixels, and each pixel has a corresponding pixel value. According to the coordinate position (i, j) corresponding to i and j, coordinates of the position are used as the point P, and the pixel value corresponding to the point P in the image frame is read.

The pixel value includes a luminance value Luma and a chrominance value Chroma.

The luminance value is configured for measuring picture display luminance of the image frame, and the chrominance value is configured for measuring color saturation of the image frame.

Operation 1216: Redesign the pixel value of the point P, where an original Luma value of the luminance value is maintained, and two components of Chroma are set to 128.

After the luminance value and the chrominance value corresponding to the point P are read, the value corresponding to the luminance value remains unchanged.

The chrominance value includes two color difference components: U and V, where U represents a difference between blue and the luminance, V represents a difference between red and the luminance, and U and V are configured for determining the color saturation of the image frame.

Component values of U and V in the chrominance value of the point P are both set to 128.

Operation 1217: j++.

In other words, the parameter j in the counter is set to be auto-incremented; and may increase by 1, or may increase by any other positive integer.

Operation 1218: j=0, and i++.

In other words, the parameter j in the counter is set to zero, i in the counter is auto-incremented, and operation 1213 is performed.

i may increase by 1, or may increase by any other positive integer.

Operation 1219: End the procedure.

For example, when operation 1213 indicates that all the pixels of the image frame have been processed, the procedure shown in FIG. 12 is ended.

In one embodiment, description is made by using an example in which the first picture display effect is a sharpen effect.

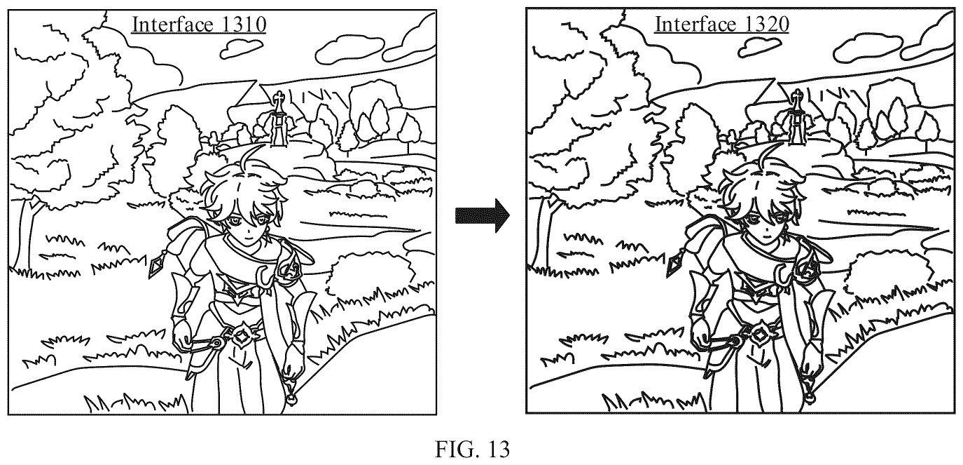

FIG. 13 is a schematic diagram of an interface of performing sharpen effect conversion on a virtual scene picture. An interface 1310 is the virtual scene picture. If the first picture display effect is the sharpen effect (a sharpen filter), an interface 1320 is obtained. Compared with the interface 1310, the interface 1320 has a clearer image edge. Sharpening, as an image processing method, reduces blur in an image and enhances detail edges and contours of the image by enhancing high-frequency components.

In one embodiment, description is made by using an example in which the first picture display effect is a pencil painting style.

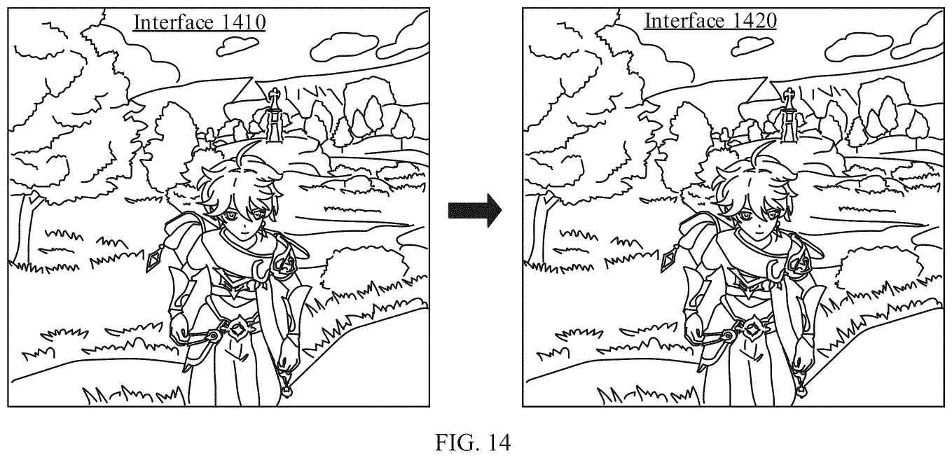

FIG. 14 is a schematic diagram of an interface of performing pencil display effect conversion on a virtual scene picture.

An interface 1410 is the virtual scene picture. If the first picture display effect is the pencil display effect (a pencil painting filter), an interface 1420 is obtained. Compared with the interface 1410, content in the interface 1420 is presented in a pencil painting form, and a stereoscopic effect is presented by using lines.

The foregoing different picture display effects are respectively processed by using corresponding image processing methods. For example, the image frame is converted into a grayscale image frame, the image frame is divided into small boxes (for example, 4*4, 6*6, . . . ), and statistics on pixel values of pixels in each small box are acquired; grayscale values of the pixels in the box are quantized, and a quantities of pixels of different levels are counted; pixels having a largest grayscale level in the box are found, and an average value of grayscale values of the pixels is calculated; and the pixel values of the original pixels are replaced with the average value, thereby implementing an oil painting effect conversion process. The foregoing descriptions are merely exemplary examples. These are not limited in the embodiments of this application.

In other words, the picture is implemented as the video image frame sequence, and image processing is performed on the video image frame sequence frame by frame by using the picture adjustment strategy corresponding to the first picture display effect, so that the adjusted video image frame sequence is encoded according to the sequence order corresponding to the video image frame sequence. In this way, accuracy of the second picture data can be ensured, omission of image processing on an image frame can be avoided.

In an exemplary embodiment, the image processing methods respectively corresponding to the different picture display effects are implemented by using pre-trained different image processing models.

For example, the oil painting effect conversion process is implemented by using an image processing model A; and the ink effect conversion process is implemented by using an image processing model B. Different image processing models are respectively pre-trained. For example, the image processing model A is a model trained by using a plurality of original images and oil painting images respectively corresponding to the plurality of original images; and the image processing model B is a model trained by using a plurality of original images and ink images respectively corresponding to the plurality of original images.

Operation 1070: The cloud server performs transmission to the terminal.

For example, after the cloud server processes the image frames by using a display effect processing strategy corresponding to a picture display effect, the cloud server encodes processed image frames to form the second picture data, and returns the second picture data to the terminal, thereby completing the display effect conversion process of the cloud server end.

The second picture data is formed after the image frames encoded. Therefore, the second picture data represents the plurality of image frames on which display effect conversion has been performed, and also represents encoding situations respectively corresponding to the plurality of image frames.

In one embodiment, the processed image frames are encoded based on the frame sequence of the image frames. For example, the frame sequence of the plurality of image frames is implemented as an image frame 1, an image frame 2, an image frame 3, and the like. Then, after display effect conversion is completed on the plurality of image frames, a processed image frame 1, a processed image frame 2, a processed image frame 3, and the like are obtained. The plurality of processed image frames are encoded according to the frame sequence of the plurality of image frames, to avoid a mistake in the order of the image frames, thereby obtaining the second picture data.

After the cloud server transmits the second picture data to the terminal, the terminal renders the second picture data on a screen, to display the virtual scene picture having the first picture display effect.

The foregoing descriptions are merely exemplary examples. These are not limited in the embodiments of this application.

In conclusion, a cloud server is used to adjust a picture display effect of a virtual scene picture, to avoid a limitation that the picture display effect can be changed only after the picture display effect is locally downloaded. The cloud server can be used to efficiently and targetedly adjust first picture data corresponding to the virtual scene picture, thereby improving flexibility and improving efficiency of displaying the virtual scene picture having a first picture display effect.

In the embodiments of this application, the process in which the terminal performs interaction with the cloud server to implement picture display effect adjustment is introduced. When the terminal needs to adjust the virtual scene picture based on the selection operation of the player, the terminal does not directly download and then apply the first picture display effect selected by the player, but transmits the first picture display effect and the display effect intensity to the cloud server. The cloud server determines the display effect adjustment strategy during image processing according to the first picture display effect, and determines the intensity parameter set during the image processing by using the display effect intensity, so that the cloud server adjusts the first picture data by using the display effect adjustment strategy and the intensity parameter set, and obtains the second picture data. The terminal directly uses the second picture data as picture content that the terminal needs to present, without an additional downloading and rendering process, thereby greatly improving efficiency of picture display effect conversion. Picture display effect conversion is beneficial to increasing replayability of an old-version game, improving game playability, enhancing sustainability and development potential of the game, and improving retention and activeness of players.

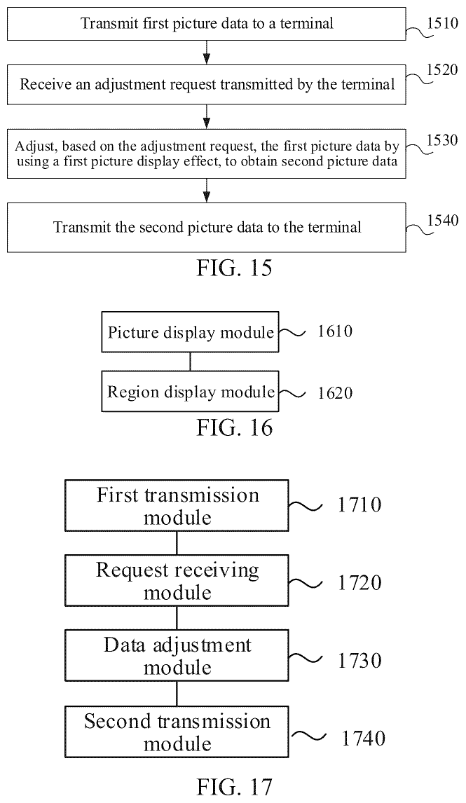

In an exemplary embodiment, FIG. 15 is a flowchart of a method for displaying a virtual scene picture performed by a cloud server. The method for displaying a virtual scene picture includes operation 1510 to operation 1540 described below. Operation 1510: Transmit first picture data to a terminal.

The terminal is configured to render the first picture data to obtain a virtual scene picture.

Operation 1520: Receive an adjustment request transmitted by the terminal.

The adjustment request is configured for adjusting the virtual scene picture to the virtual scene picture having a first picture display effect. The first picture display effect is a picture display effect determined based on a selection operation for an effect switching region.

In one embodiment, the effect switching region includes at least one candidate picture display effect.

The picture display effect is configured for representing picture display of the virtual scene picture. For example, the picture display effect is a display situation such as a picture filter or a picture special effect (for example, an added star special effect or a bright light special effect).

Operation 1530: Adjust, based on the adjustment request, the first picture data by using the first picture display effect, to obtain second picture data.

The second picture data is configured for rendering by the terminal to obtain the virtual scene picture having the first picture display effect.

In an exemplary embodiment, the first picture display effect is determined based on the selection operation; a picture adjustment strategy corresponding to the first picture display effect is determined; and the second picture data is transmitted.

The picture adjustment strategy is configured for adjusting the first picture data by using the picture display effect and obtaining the second picture data; and

In an exemplary embodiment, a video image frame sequence is obtained. The video image frame sequence includes a plurality of image frames starting at a current moment. In some embodiments, image processing is performed on the video image frame sequence by using the picture adjustment strategy corresponding to the first picture display effect, to obtain a processed video image frame sequence. In some embodiments, the processed video image frame sequence is encoded based on a sequence order corresponding to the video image frame sequence, to obtain the second picture data.

Operation 1540: Transmit the second picture data to the terminal.

In conclusion, a cloud server is used to adjust a picture display effect of a virtual scene picture, to avoid a limitation that the picture display effect can be changed only after the picture display effect is locally downloaded. The cloud server can be used to efficiently and targetedly adjust first picture data corresponding to the virtual scene picture, thereby improving flexibility and improving efficiency of displaying the virtual scene picture having a first picture display effect.

In the embodiments of this application, the content in which the cloud server performs display effect conversion based on the selection operation performed on the terminal is introduced. The terminal does not directly download and then apply the first picture display effect selected by a player, but transmits the first picture display effect to the cloud server. The cloud server applies the first picture display effect to the virtual scene picture, and generates the second picture data on which display effect adjustment has been performed, so that when the cloud server transmits picture data configured for rendering to the terminal, the cloud server directly transmits, to the terminal, the second picture data on which the display effect adjustment has been performed. In this way, game playability is improved based on a feature of a cloud game, and efficiency of human-computer interaction is improved.

FIG. 16 is a structural block diagram of an apparatus for displaying a virtual scene picture according to an exemplary embodiment of this application. As shown in FIG. 16, the apparatus includes the following parts:
a picture display module 1610, configured to display a virtual scene picture of a cloud game, the virtual scene picture being a picture obtained by rendering first picture data transmitted by a cloud server; and
a region display module 1620, configured to display an effect switching region in response to that a display effect switching operation is received, the effect switching region including at least one candidate picture display effect,
the picture display module 1610 being further configured to display, based on a selection operation for a first picture display effect in the at least one candidate picture display effect, the virtual scene picture having the first picture display effect, the virtual scene picture having the first picture display effect being a picture obtained by rendering second picture data transmitted by the cloud server, and the second picture data being data obtained by adjusting the first picture data by using the first picture display effect by the cloud server.

In an exemplary embodiment, the picture display module 1610 is further configured to display an effect intensity adjustment region based on the selection operation for the first picture display effect in the at least one candidate picture display effect, the effect intensity adjustment region being configured for adjusting display effect intensity of the first picture display effect, and the display effect intensity indicating a visual effect of the picture display effect; receive a display adjustment operation in the effect intensity adjustment region, the adjustment operation being configured for adjusting the display effect intensity to first display effect intensity under the first picture display effect; and display the virtual scene picture having the first picture display effect in which the first picture display effect corresponds to the first display effect intensity.

In an exemplary embodiment, the effect intensity adjustment region is a display effect intensity adjustment slot, and the display effect intensity adjustment slot is configured for adjusting the display effect intensity of the picture display effect; and
the picture display module 1610 is further configured to receive a slide operation for the display effect intensity adjustment slot as the display adjustment operation; or receive a click operation for the display effect intensity adjustment slot as the display adjustment operation.

In an exemplary embodiment, the display effect intensity adjustment slot includes a plurality of display effect intensity selection points, the display effect intensity selection points being configured for distinguishing different display effect intensity; and
the picture display module 1610 is further configured to receive a click operation for a display effect intensity selection point corresponding to the first display effect intensity in the display effect intensity adjustment slot as the display adjustment operation.

In an exemplary embodiment, the region display module 1620 is further configured to display the at least one candidate picture display effect and a display effect identifier respectively corresponding to the at least one candidate picture display effect, the display effect identifier being configured for previewing an effect of applying the candidate picture display effect.

In an exemplary embodiment, the region display module 1620 is further configured to receive a selection operation for a display effect identifier corresponding to a second picture display effect in the at least one candidate picture display effect, the second picture display effect being any picture display effect in the at least one candidate picture display effect; and display, based on the selection operation, a preview effect of applying the second picture display effect.

In an exemplary embodiment, the region display module 1620 is further configured to receive a stay operation for the display effect identifier as the selection operation; or receive a click operation for the display effect identifier as the selection operation.

In an exemplary embodiment, the region display module 1620 is further configured to display, based on the selection operation, the preview effect of applying the second picture display effect to a current virtual scene picture; or display, based on the selection operation, the preview effect of applying the second picture display effect to a preset virtual scene picture.

In an exemplary embodiment, the region display module 1620 is further configured to overlay-display a preview effect window on the virtual scene picture based on the selection operation, a comparison effect of not applying the second picture display effect being displayed on a first side of the preview effect window, and the preview effect of applying the second picture display effect being displayed on a second side of the preview effect window.

In an exemplary embodiment, the preview effect window includes a display effect intensity preview slot, the display effect intensity preview slot being configured for presenting preview effects of different display effect intensity; and
the region display module 1620 is further configured to receive a slide operation for the display effect intensity preview slot; and when the slide operation indicates second display effect intensity, display, in the preview effect window, the preview effect of applying the second picture display effect in which the second picture display effect corresponds to the second display effect intensity.

In an exemplary embodiment, the method is applied to a terminal, and a first account is logged in to the terminal; and
the picture display module 1610 is further configured to determine an account benefit of the first account, the account benefit including an application condition of the first account for the candidate picture display effect; match the first picture display effect with the account benefit based on the selection operation for the first picture display effect in the at least one candidate picture display effect, to obtain a matching result; and display the virtual scene picture having the first picture display effect when the matching result indicates that the account benefit includes a condition for using the first picture display effect.

In an exemplary embodiment, the picture display module 1610 is further configured to transmit a picture display effect application request to the cloud server when the matching result indicates that the account benefit includes the condition for using the first picture display effect, the picture display effect application request being configured for indicating the cloud server to apply the first picture display effect to the virtual scene picture; receive the second picture data transmitted by the cloud server, the second picture data being data obtained by applying the first picture display effect to the virtual scene picture; and display the virtual scene picture having the first picture display effect based on the second picture data.

In an exemplary embodiment, the at least one candidate picture display effect each corresponds to one picture adjustment strategy; and
the cloud server is further configured to determine the first picture display effect based on the selection operation; determine a picture adjustment strategy corresponding to the first picture display effect, the picture adjustment strategy being configured for adjusting the first picture data by using the picture display effect and obtaining the second picture data; and transmit the second picture data.

In an exemplary embodiment, the cloud server is further configured to obtain a video image frame sequence, the video image frame sequence including a plurality of image frames starting at a current moment; perform image processing on the video image frame sequence by using the picture adjustment strategy corresponding to the first picture display effect, to obtain a processed video image frame sequence; and encode the processed video image frame sequence based on a sequence order corresponding to the video image frame sequence, to obtain the second picture data.

In an exemplary embodiment, FIG. 17 is a structural block diagram of an apparatus for displaying a virtual scene picture according to another exemplary embodiment of this application. As shown in FIG. 17, the apparatus includes the following parts:
a first transmission module 1710, configured to transmit first picture data to a terminal, the terminal being configured to render the first picture data to obtain a virtual scene picture;
a request receiving module 1720, configured to receive an adjustment request transmitted by the terminal, the adjustment request being configured for adjusting the virtual scene picture to the virtual scene picture having a first picture display effect, the first picture display effect being a picture display effect determined based on a selection operation for an effect switching region, and the effect switching region including at least one candidate picture display effect;
a data adjustment module 1730, configured to adjust, based on the adjustment request, the first picture data by using the first picture display effect, to obtain second picture data, the second picture data being configured for rendering by the terminal to obtain the virtual scene picture having the first picture display effect; and
a second transmission module 1740, configured to transmit the second picture data to the terminal.

The apparatus for displaying a virtual scene picture provided in the foregoing embodiments is illustrated with an example of division of the foregoing functional modules.

In actual application, the functions may be allocated to and completed by different functional modules according to requirements, that is, the internal structure of the device is divided into different functional modules, to implement all or some of the functions described above. In this application, the term “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. In addition, the apparatus for displaying a virtual scene picture provided in the foregoing embodiments belongs to the same concept as the embodiments of the method for displaying a virtual scene picture. For a specific implementation process of the apparatus, reference is made to the method embodiments. Details are not described herein again.

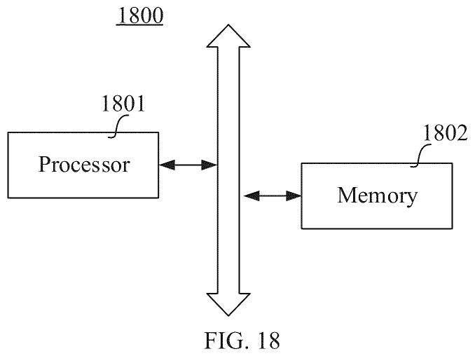

FIG. 18 is a structural block diagram of an electronic device 1800 according to an exemplary embodiment of this application. The electronic device 1800 may be a portable mobile terminal, such as a smartphone, a tablet computer, an in-vehicle terminal, a moving picture experts group audio layer III (MP3) player, a moving picture experts group audio layer IV (MP4) player, a notebook computer, or a desktop computer. The electronic device 1800 may also be referred to as another name such as user equipment, a portable terminal, a laptop terminal, or a desktop terminal.

Generally, the electronic device 1800 includes a processor 1801 and a memory 1802.

The processor 1801 may include one or more processing cores, and may be, for example, a 4-core processor or an 8-core processor. The processor 1801 may be implemented by using at least one hardware form of a digital signal processor (DSP), a field-programmable gate array (FPGA), and a programmable logic array (PLA). The processor 1801 may alternatively include a main processor and a coprocessor. The main processor is configured to process data in an active state, also referred to as a central processing unit (CPU). The coprocessor is a low-power consumption processor configured to process data in a standby state. In some embodiments, the processor 1801 may be integrated with a graphics processing unit (GPU). The GPU is configured to render and draw content that needs to be displayed on a display screen. In some embodiments, the processor 1801 may further include an artificial intelligence (AI) processor. The AI processor is configured to process computing operations related to machine learning.

The memory 1802 may include one or more computer-readable storage media. The computer-readable storage media may be non-transient. The memory 1802 may also include a high-speed random access memory, as well as non-volatile memory, such as one or more disk storage devices and flash storage devices. In some embodiments, a non-transitory computer-readable storage medium in the memory 1802 is configured to store at least one instruction, the at least one instruction being configured to be executed by the processor 1801 to implement the method for displaying a virtual scene picture according to the method embodiments of this application.

In some embodiments, the electronic device 1800 may also include one or more sensors. The one or more sensors include, but not limited to, a proximity sensor, a gyroscope sensor, and a pressure sensor.

The proximity sensor, also referred to as a distance sensor, is usually arranged on a front panel of the electronic device 1800. The proximity sensor is configured to acquire a distance between a user and a front surface of the electronic device 1800.

The gyroscope sensor may detect a body direction and a rotation angle of the electronic device 1800. The gyroscope sensor may cooperate with an acceleration sensor to acquire a 3D action by the user on the electronic device 1800. The processor 1801 may implement the following functions according to the data acquired by the gyroscope sensor: motion sensing (such as changing the UI according to a tilt operation of the user), image stabilization at shooting, game control, and inertial navigation.

The pressure sensor may be arranged on a side frame of the electronic device 1800 and/or a lower layer of the display screen. When the pressure sensor is arranged on the side frame of the electronic device 1800, a holding signal of the user on the electronic device 1800 may be detected, and the processor 1801 may perform left/right hand identification or a quick operation according to the holding signal collected by the pressure sensor. When the pressure sensor is arranged on the lower layer of the display screen, the processor 1801 controls, according to a pressure operation of the user on the display screen, an operable control on an interface of the UI. The operable control includes at least one of a button control, a scroll bar control, an icon control, and a menu control.

In some embodiments, the electronic device 1800 further includes other component parts. A person skilled in the art may understand that the structure shown in FIG. 18 constitutes no limitation on the electronic device 1800, and the electronic device may include more or fewer components than those shown in the figure, or some components may be combined, or a different component deployment may be used.

An embodiment of this application further provides a computer device. The computer device may be implemented as the terminal or the server shown in FIG. 2. The computer device includes a processor and a memory, the memory having at least one instruction, at least one program, a code set, or an instruction set stored therein, the at least one instruction, the at least one program, the code set, or the instruction set being loaded and executed by the processor to implement the method for displaying a virtual scene picture according to the foregoing method embodiments.

An embodiment of this application further provides a non-transitory computer-readable storage medium, having at least one instruction, at least one program, a code set, or an instruction set stored therein, the at least one instruction, the at least one program, the code set, or the instruction set being loaded and executed by a processor to implement the method for displaying a virtual scene picture according to the foregoing method embodiments.

An embodiment of this application further provides a computer program product or a computer program, including computer instructions, the computer instructions being stored in a computer-readable storage medium. A processor of a computer device reads the computer instructions from the computer-readable storage medium and executes the computer instructions, to cause the computer device to perform the method for displaying a virtual scene picture according to any one of the foregoing embodiments.

In one embodiment, the computer-readable storage medium may include: a read-only memory (ROM), a random access memory (RAM), a solid state drive (SSD), an optical disc, or the like. The RAM may include a resistance random access memory (ReRAM) and a dynamic random access memory (DRAM). The sequence numbers of the foregoing embodiments of this application are merely for description purpose, and are not intended to indicate priorities of the embodiments.

What is claimed is:

1. A method for updating a virtual scene picture performed by a computer device, the method comprising:
displaying a virtual scene picture of a cloud game transmitted by a cloud server, wherein the virtual scene picture is generated by the cloud server by rendering first picture data according to a default display effect;
displaying an effect switching region comprising at least one candidate picture display effect;
submitting, based on a user selection operation for a first picture display effect in the at least one candidate picture display effect, the first picture display effect to the cloud server, wherein the first picture display effect is different from the default display effect;
receiving second picture data transmitted by the cloud server, wherein the second picture data is generated by the cloud server by adjusting the first picture data according to the first picture display effect; and
updating the virtual scene picture to have the first picture display effect by rendering the second picture data transmitted by the cloud server.

2. The method according to claim 1, wherein the updating the virtual scene picture to have the first picture display effect comprises:
displaying an effect intensity adjustment region based on the user selection operation for the first picture display effect in the at least one candidate picture display effect;
receiving an adjustment operation in the effect intensity adjustment region; and
updating the virtual scene picture to have the first picture display effect in accordance with the first display effect intensity.

3. The method according to claim 2, wherein the effect intensity adjustment region is an effect intensity adjustment slot, and the effect intensity adjustment slot is configured for adjusting the display effect intensity of the picture display effect.

4. The method according to claim 1, wherein the displaying an effect switching region comprises:
displaying the at least one candidate picture display effect and a display effect identifier respectively corresponding to the at least one candidate picture display effect, the display effect identifier being configured for previewing an effect of applying the candidate picture display effect.

5. The method according to claim 4, wherein after the displaying the at least one candidate picture display effect and a display effect identifier respectively corresponding to the at least one candidate picture display effect, the method further comprises:
receiving a user selection operation for a display effect identifier corresponding to a second picture display effect in the at least one candidate picture display effect; and
displaying, based on the user selection operation, a preview effect of applying the second picture display effect.

6. The method according to claim 5, wherein the displaying, based on the user selection operation, a preview effect of applying the second picture display effect comprises:
displaying the preview effect of applying the second picture display effect to a currently displayed virtual scene picture.

7. The method according to claim 1, wherein the at least one candidate picture display effect each corresponds to one picture adjustment strategy, the picture adjustment strategy being configured for adjusting the first picture data by using the picture display effect and obtaining the second picture data by the cloud server.

8. The method according to claim 7, wherein the second picture data is obtained by performing image processing on a video image frame sequence by using the picture adjustment strategy corresponding to the first picture display effect to obtain a processed video image frame sequence and encoding the processed video image frame sequence based on a sequence order corresponding to the video image frame sequence by the cloud server.

9. A computer device, comprising a processor and a memory, the memory having at least one program stored therein, the at least one program, when executed by the processor, causing the computer device to implement a method for updating a virtual scene picture including:
displaying a virtual scene picture of a cloud game transmitted by a cloud server, wherein the virtual scene picture is generated by the cloud server by rendering first picture data according to a default display effect;
displaying an effect switching region comprising at least one candidate picture display effect;
submitting, based on a user selection operation for a first picture display effect in the at least one candidate picture display effect, the first picture display effect to the cloud server, wherein the first picture display effect is different from the default display effect;
receiving second picture data transmitted by the cloud server, wherein the second picture data is generated by the cloud server by adjusting the first picture data according to the first picture display effect; and
updating the virtual scene picture to have the first picture display effect by rendering the second picture data transmitted by the cloud server.

10. The computer device according to claim 9, wherein the updating the virtual scene picture to have the first picture display effect comprises:
displaying an effect intensity adjustment region based on the user selection operation for the first picture display effect in the at least one candidate picture display effect;
receiving an adjustment operation in the effect intensity adjustment region; and
updating the virtual scene picture to have the first picture display effect in accordance with the first display effect intensity.

11. The computer device according to claim 10, wherein the effect intensity adjustment region is an effect intensity adjustment slot, and the effect intensity adjustment slot is configured for adjusting the display effect intensity of the picture display effect.

12. The computer device according to claim 9, wherein the displaying an effect switching region comprises:
displaying the at least one candidate picture display effect and a display effect identifier respectively corresponding to the at least one candidate picture display effect, the display effect identifier being configured for previewing an effect of applying the candidate picture display effect.

13. The computer device according to claim 12, wherein after the displaying the at least one candidate picture display effect and a display effect identifier respectively corresponding to the at least one candidate picture display effect, the method further comprises:
receiving a user selection operation for a display effect identifier corresponding to a second picture display effect in the at least one candidate picture display effect; and
displaying, based on the user selection operation, a preview effect of applying the second picture display effect.

14. The computer device according to claim 13, wherein the displaying, based on the user selection operation, a preview effect of applying the second picture display effect comprises:
displaying the preview effect of applying the second picture display effect to a currently displayed virtual scene picture.

15. The computer device according to claim 9, wherein the at least one candidate picture display effect each corresponds to one picture adjustment strategy, the picture adjustment strategy being configured for adjusting the first picture data by using the picture display effect and obtaining the second picture data by the cloud server.

16. The computer device according to claim 15, wherein the second picture data is obtained by performing image processing on a video image frame sequence by using the picture adjustment strategy corresponding to the first picture display effect to obtain a processed video image frame sequence and encoding the processed video image frame sequence based on a sequence order corresponding to the video image frame sequence by the cloud server.

17. A non-transitory computer-readable storage medium, having at least one program stored therein, the at least one program, when executed by a processor of a computer device, causing the computer device to implement a method for updating a virtual scene picture including:
displaying a virtual scene picture of a cloud game transmitted by a cloud server, wherein the virtual scene picture is generated by the cloud server by rendering first picture data according to a default display effect;
displaying an effect switching region comprising at least one candidate picture display effect;
submitting, based on a user selection operation for a first picture display effect in the at least one candidate picture display effect, the first picture display effect to the cloud server, wherein the first picture display effect is different from the default display effect;
receiving second picture data transmitted by the cloud server, wherein the second picture data is generated by the cloud server by adjusting the first picture data according to the first picture display effect; and
updating the virtual scene picture to have the first picture display effect by rendering the second picture data transmitted by the cloud server.

18. The non-transitory computer-readable storage medium according to claim 17, wherein the updating the virtual scene picture to have the first picture display effect comprises:
displaying an effect intensity adjustment region based on the user selection operation for the first picture display effect in the at least one candidate picture display effect;
receiving an adjustment operation in the effect intensity adjustment region; and
updating the virtual scene picture to have the first picture display effect in accordance with the first display effect intensity.

19. The non-transitory computer-readable storage medium according to claim 17, wherein the displaying an effect switching region comprises:
displaying the at least one candidate picture display effect and a display effect identifier respectively corresponding to the at least one candidate picture display effect, the display effect identifier being configured for previewing an effect of applying the candidate picture display effect.

20. The non-transitory computer-readable storage medium according to claim 17, wherein after the displaying the at least one candidate picture display effect and a display effect identifier respectively corresponding to the at least one candidate picture display effect, the method further comprises:
receiving a user selection operation for a display effect identifier corresponding to a second picture display effect in the at least one candidate picture display effect; and
displaying, based on the user selection operation, a preview effect of applying the second picture display effect.
